(19) United States
(12) Patent Application Publication
(10) Pub. No.: US 2017/0059130 A1
(43) Pub. Date: Mar. 2, 2017

(54) Light Fixture with Shadow Pattern Plate

(71) Applicant: Tailored Lights, LLC, Walton, NE (US)

(72) Inventors: Jacob Sittner, Walton, NE (US); Kristina L Sittner, Walton, NE (US)

(73) Assignee: Tailored Lights, LLC, Walton, NE (US)

(21) Appl. No.: 14/833,534

(22) Filed: Aug. 24, 2015

(51) Int. Cl. F21V 11/00; F21S 8/00; F21S 9/03

(52) U.S. Cl. CPC F21V 11/00; F21S 9/037; F21S 8/032; F21Y 2101/02; F21V 23/04

(57) ABSTRACT

A light fixture is disclosed comprising an elongate tube, one or more shadow pattern plates, and a cover component. A shadow pattern plate incorporates a design pattern and creates a stylized shadow on a surface when light shines on the shadow pattern plate. A method is also disclosed for producing a light fixture with one or more shadow pattern plates.

### BACKGROUND

Landscaping can be accentuated during the evening and nighttime hours with lighting. In addition to providing safety benefits, outdoor lighting can improve the character of a landscaped space. When lighting is properly calibrated and applied, landscape lighting can significantly enhance aesthetic appearances when it is becoming or is dark outside.

Conventionally, landscape lighting may spotlight or illuminate a particular area through a projection of minimally blocked light. That is, a light source projects light onto the particular area and the light fixture that holds the light source attempts to maximize illumination of the particular area by minimizing any shadows that could be created from the structure of the light fixture. Shadows may result from structure that defines a housing for the light bulb, which forms part of the light fixture.

There is also landscape lighting that spotlights or illuminates a particular area through a projection of intentionally blocked (or obstructed) light. By incorporating a specific design into the structure that houses the one or more light bulbs, the design may be projected onto the surface as a shadow. These designs, also known as shadow patterns, can be aesthetically pleasing and further enhance the value of the landscape lighting used. The designs can take the form of swirls, arranged lines, leaves, letters, and many other shapes and forms or combinations thereof

However, current practices for designing and making light fixtures that include shadow patterns limit the light fixture to one shadow pattern per side. Owners of these light fixtures must purchase multiple fixtures even if the only change they want to make is the projected shadow pattern. This creates additional consumer costs and is an inefficient use of resources.

### SUMMARY OF THE INVENTION

A light fixture is disclosed that projects shadow patterns onto a surface. The light fixture comprising an elongate tube, one or more shadow pattern plates, and a cover component. Each shadow pattern plate creates a stylized shadow on a surface. Furthermore, the present disclosure provides for a method of producing a light fixture that projects shadow patterns onto a surface.

It is to be understood that both the foregoing general description and the following detailed description are exemplary and explanatory only and are not necessarily restrictive of the disclosure as claimed. The accompanying drawings, which are incorporated in and constitute a part of the specification, illustrate embodiments of the disclosure and together with the general description, serve to explain the principles of the disclosure.

### BRIEF DESCRIPTION OF THE DRAWINGS

The numerous advantages of the present disclosure may be better understood by those skilled in the art by reference to the accompanying figures in which:

FIG. 1 is a three-dimensional perspective view of the light fixture with shadow pattern plates fastened to the exterior of each side of the light fixture.

FIG. 2A is a zoomed-in cross-sectional view of the light fixture, focusing on the shadow pattern plates being fastened to the exterior of each side of the light fixture.

FIG. 2B is an exploded three-dimensional perspective view of the light fixture.

FIG. 3A is another zoomed-in cross-sectional view of the light fixture, focusing on the shadow pattern plates being fastened to the exterior of each side of the light fixture and having an alternative disposition for the light fixture.

FIG. 3B is another exploded three-dimensional perspective view of the light fixture.

FIG. 4 is a three-dimensional perspective view of the light fixture with shadow pattern plates fastened to the interior of each side of the light fixture.

FIG. 5A-5C are exemplary embodiments of different shadow pattern plate designs.

### DETAILED DESCRIPTION

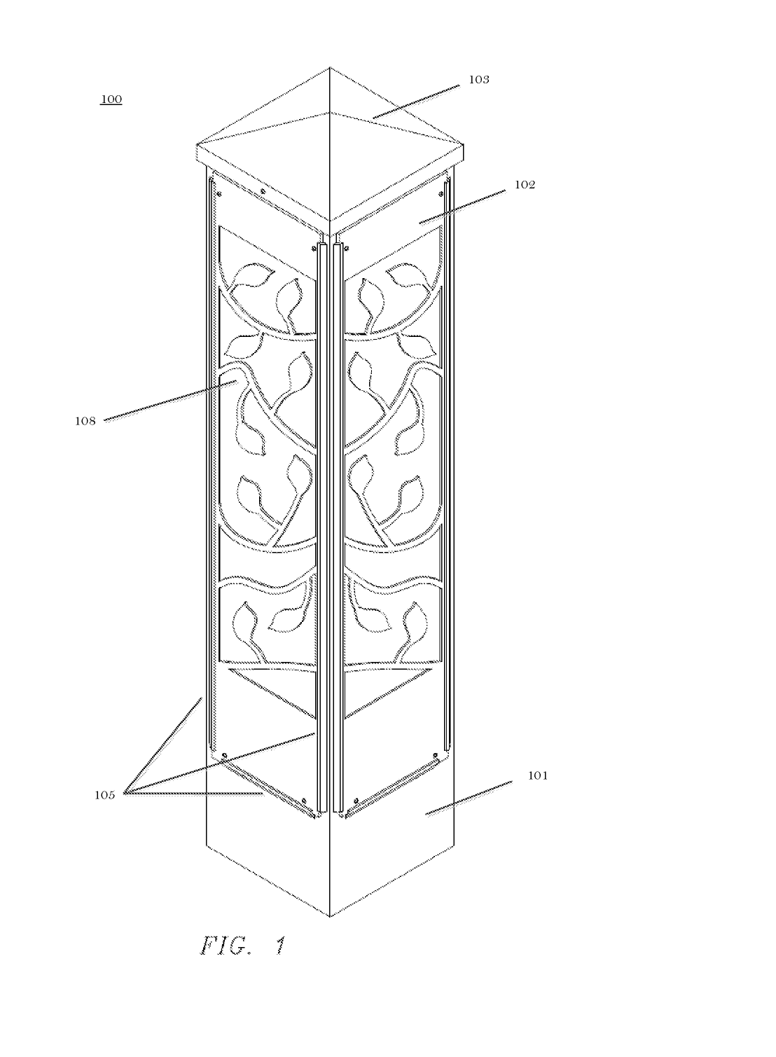

The present disclosure describes a light fixture that projects a shadow pattern onto a surface. Referring to FIG. 1, the light fixture 100 comprises an elongate tube 101, one or more shadow pattern plates 102, and a cover component 103. The elongate tube 101 is seen in FIG. 1 with a square horizontal cross-sectional shape. In other embodiments of the present disclosure, the elongate tube 101 may be another horizontal cross-sectional shape, such as rectangular or circular. The elongate tube 101 may have sides casted from metal, such as aluminum, iron or steel. In other embodiments, the sides of the elongate tube 101 may be cast, molded, cut, woven, or otherwise produced using other materials, such as plastic, ceramic, glass, or wicker.

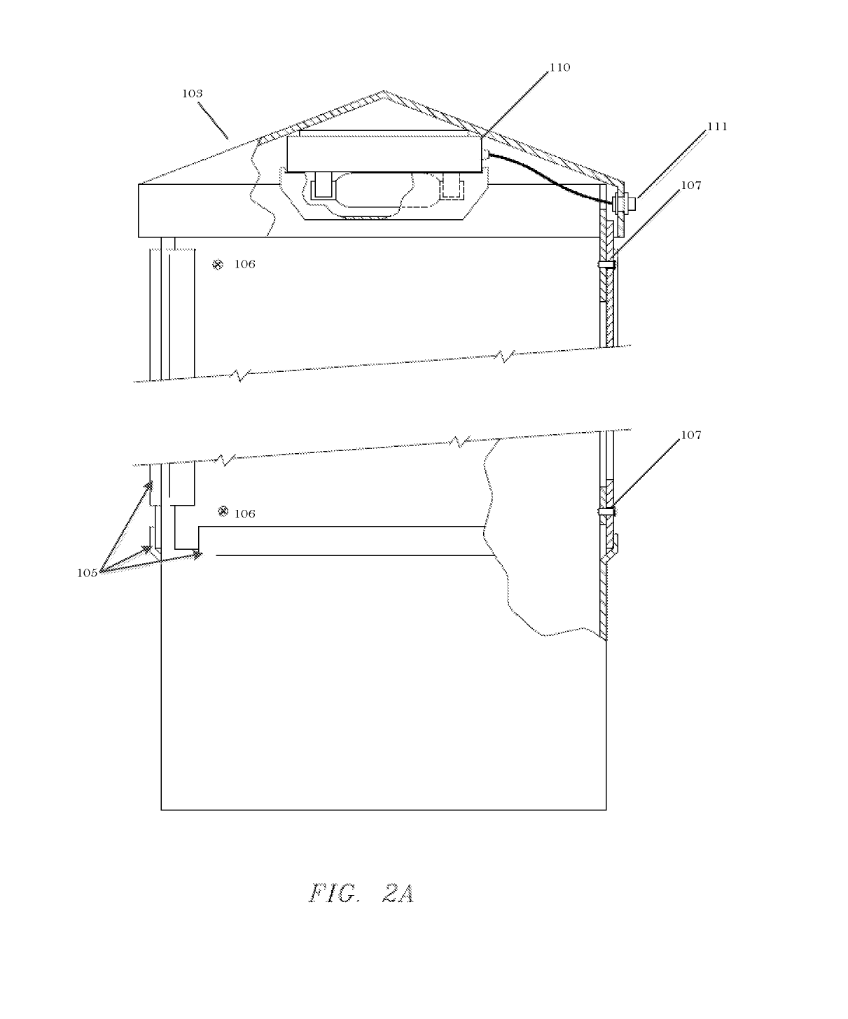

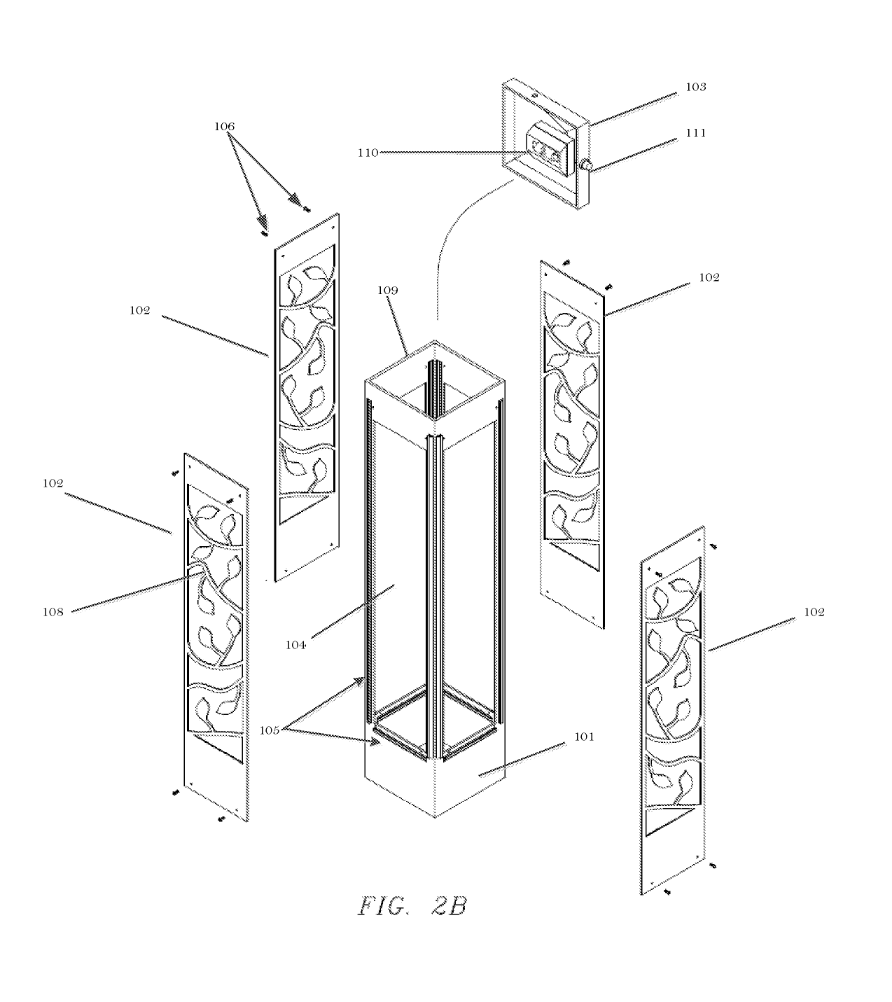

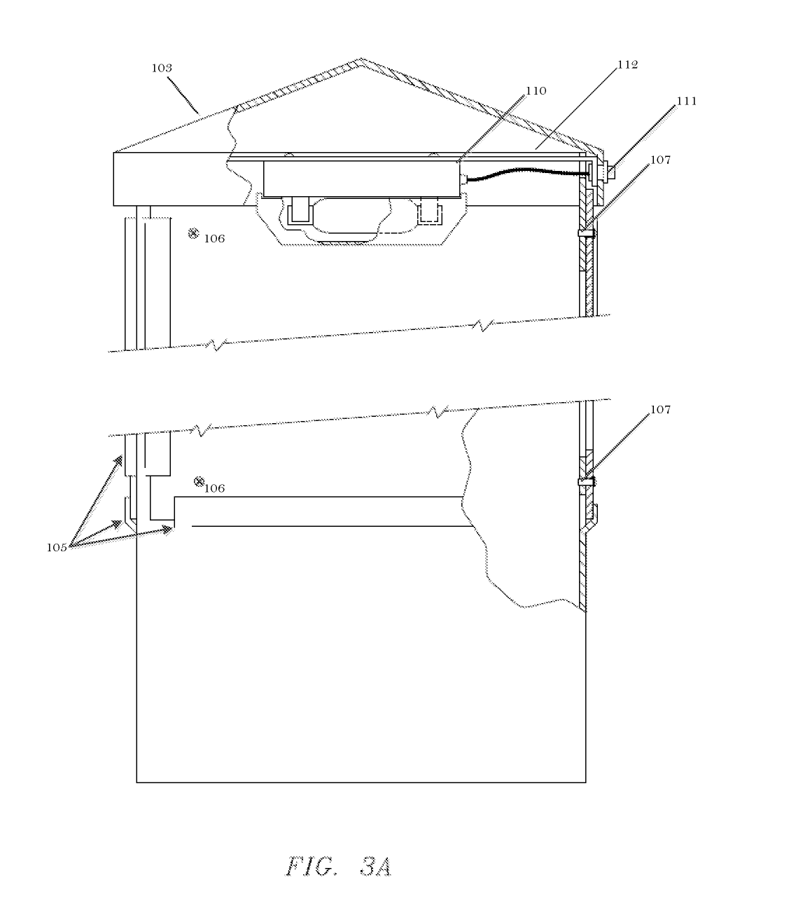

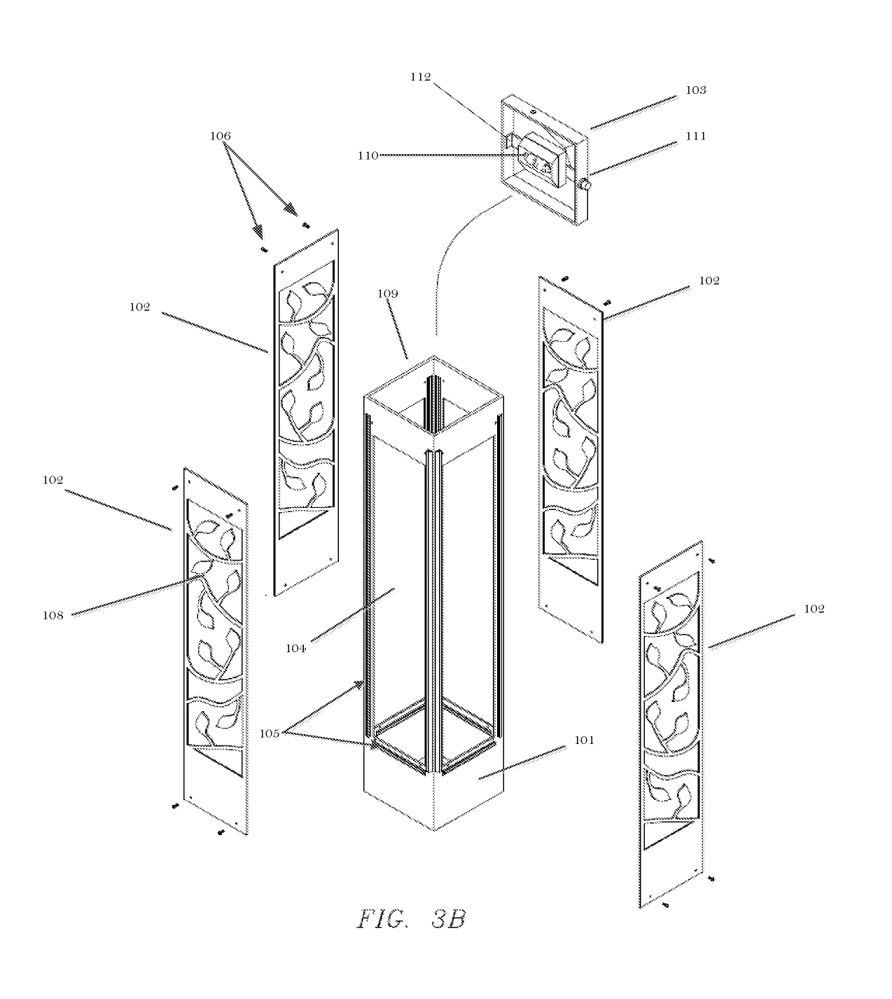

The elongate tube 101 comprises a hollow inner volume. The hollow inner volume is the space through which light passes from a light source 110, seen in FIG. 2B and 3B. Furthermore, the elongate tube 101 may comprise a base for setting the light fixture 100 on a surface. In some embodiments, the base is a continuous part of the elongate tube 101. In other embodiments, the base may be detachable and configured to connect with a bottom portion of a plurality of sides to the elongate tube 101. In either embodiment, the base of the elongate tube 101 may be constructed or formed from the same material or different as the sides to the elongate tube 101. Additionally, or in the alternative, the base may be constructed or formed from material selected for its weight, in order to help anchor the light fixture 100 to the surface upon which it is disposed. For example, the base may be made using aluminum, iron, or steel to increase the weight of the light fixture 100.

In embodiments of the present disclosure, the base of the elongate tube 101 is also configured to be anchored into the surface on which the light fixture is disposed. In such embodiments, the anchoring is another factor in addition to the weight of the light fixture 100 for keeping the light fixture standing upright. The means used for anchoring the base into the surface preferably depend upon the surface. For example, the base may be anchored into a surface using one or more rigid stakes if the light fixture 100 is being set onto grass, mulch, soil, or a combination thereof. Such stakes could be driven through tabs (or wings) that extend away from each side of the bottom of the base and include apertures for receiving the stakes.

The elongate tube 101 includes one or more cutout sections 104. A cutout section 104 is a void portion of a side on the elongate tube 101. A cutout section 104 to the elongate tube 101 may have an outline that is rectangular, square, or another shape. For example, when the elongate tube 101 is a rectangular prism (or cuboid) (i.e., it has a square or rectangular horizontal cross-sectional shape), each side to the elongate tube 101 is substantially two-dimensional so it is preferable that the cutout section 104 is also substantially two-dimensional and rectangular. However, in other embodiments of the present disclosure, a cutout section 104 may be more three-dimensional—for example, if the elongate tube 101 is a cylinder (i.e., it has a horizontal cross-sectional shape that is circular or oval), then the cutout section 104 will have curvature in its outline of the curved surface to the elongate tube 101. A cutout section 104 may be created by a variety of means and/or combinations thereof. For example, in an embodiment where the elongate tube 101 is created from iron, then the one or more cutout sections 104 may be created using an iron cutting reciprocating saw.

The void portion of a cutout section 104 in the elongate tube 101 is a frame for a shadow pattern plate 102. A shadow pattern plate 102 may be configured to be framed by a cutout section 104. In one embodiment of the present disclosure, the elongate tube 101 is configured to receive a shadow pattern plate 102 on the outward facing (or exterior) surface of each side to the elongate tube 101. In another embodiment of the present disclosure, the elongate tube 101 is configured to receive a shadow pattern plate 102 on the inward facing (or interior) surface of each side to the elongate tube 101. As demonstrated in FIG. 2B and 3B, configurations of the elongate tube 101 to receive a shadow pattern plate 102 are aligned with cutout sections 104 in order for the cutout sections 104 to frame each shadow pattern plate 102 set into means for receiving the shadow pattern plate 102.

As seen in FIG. 1 and FIG. 2A and 3A, receiving a shadow pattern plate 102 may be accomplished or supported using one or more pattern slots 105 that outline the framing formed by the one or more cutout sections 104. As an example of the present embodiment, an exemplary pattern slot 105 in FIG. 2A is disposed width-wise across a portion of each side to the elongate tube 101. Also seen in FIG. 1 and FIG. 2A and 3A, there are pattern slots 105 disposed length-wise along portions of the sides of the elongate tube 101. Each pattern slot 105 is defined by a portion of the surface to a side of the elongate tube 101, a lip extending from the surface of the elongate tube 101 along said portion, and a wall extending from the lip, where the surface of the wall is substantially parallel with the surface of the side and the surface of the wall is substantially perpendicular or angled (e.g., angle equal to or greater than 90 degrees) to the surface of the lip.

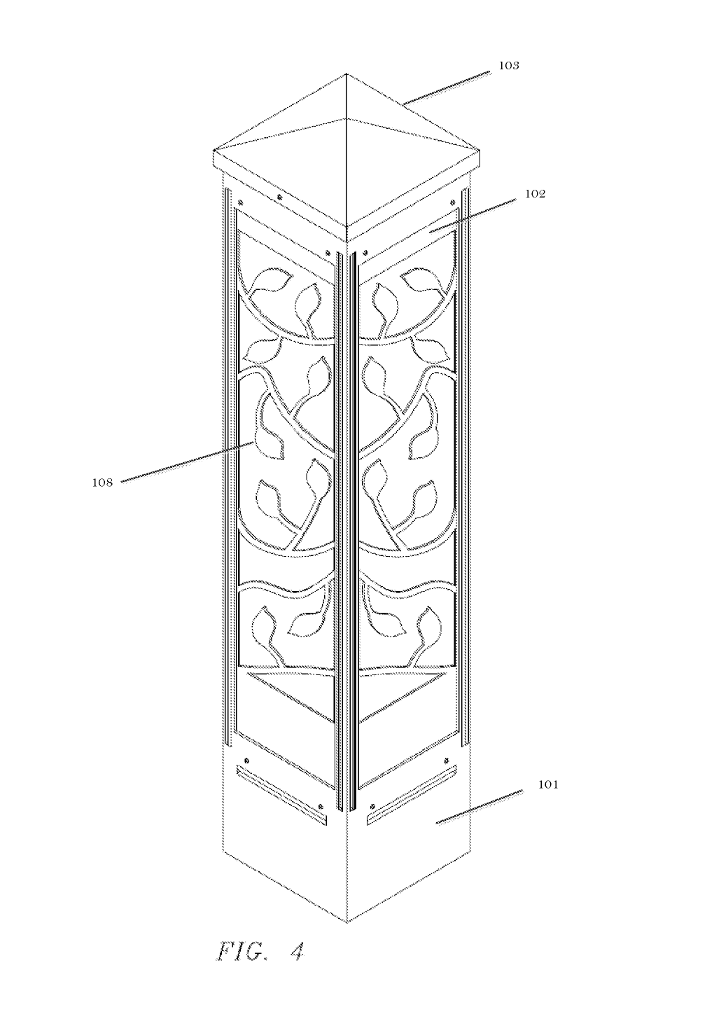

In embodiments where the shadow pattern plates 102 are disposed and secured upon the interior of the elongate tube 101 (see FIG. 4), the pattern slots 105 may be located on the interior surface of the elongate tube 101 instead of on its exterior surface. In such embodiments, the pattern slots 105 would be similar to those slots disposed on the exterior surface of the elongate tube 101 in embodiments seen in FIG. 1 and FIG. 2A, except the pattern slots 105 would extend in an inward direction from the interior surface of the elongate tube 101, instead of in an outward direction from the exterior surface of the elongate tube 101.

The combination of a width-wise pattern slot with opposing length-wise pattern slots help the cutout section 104 act as a frame for a shadow pattern plate 102. A pattern slot 105 that is disposed width-wise along a portion of a side of the elongate tube 101 supports the weight of a shadow pattern plate 102. Pattern slots 105 that are disposed length-wise along portions of such a side maintain alignment of the shadow pattern plate 102 with a cutout section 104. Use of the pattern slots 105 may be independent of or in combination with securing or fastening means for the shadow pattern plates 102 to the elongate tube 101. In the embodiments of FIG. 1 and FIG. 2, the pattern slots 105 are in combination with securing (or fastening) means represented by screws 106 in FIG. 2 for the shadow pattern plates 102.

The lip and wall of a pattern slot 105 may span all or only a portion of the perimeter where the slot is disposed. That is to say a pattern slot 105 may span only a portion of a side to the elongate tube 101. For instance, if the elongate tube 101 is a rectangular prism (or cuboid) and a pattern slot 105 is disposed length-wise along the interior surface thereof, the pattern slot 105 may not span the entire length of the side where the pattern slot 105 is defined. Alternatively, however, a pattern slot 105 may span the entire side to the elongate tube 101. For instance, if the elongate tube 101 is a cylinder and a width-wise pattern slot 105 is disposed on the interior surface thereof, the pattern slot 105 may span the entire inner circumference of the elongate tube 101 where the pattern slot 105 is defined.

In embodiments of the present disclosure that use securing or fastening means for attaching a shadow pattern plate 102 to the elongate tube 101, the elongate tube 101 and the shadow pattern plate 102 each include a plurality of apertures. The plurality of apertures are exemplified in the exploded view of FIG. 3 and are used in combination with securing or fastening means. FIG. 2 offers a front view of a fastener 106 inserted in apertures of a shadow pattern plate 102. FIG. 2 also offers a side cross-sectional view 107 showing a fastener inserted into apertures on the shadow pattern plate 102 and elongate tube 101, which align to receive the fastener. Each aperture on the shadow pattern plate 102 may align with a corresponding aperture of the elongate tube 101. The aligned plurality of apertures are used in the application of means for fastening a shadow pattern plate 102 onto an elongate tube 101. Use of the plurality of apertures and means for securing or fastening the shadow pattern plates 102 to the elongate tube 101 may be independent of or in combination with use of one or more pattern slots 105.

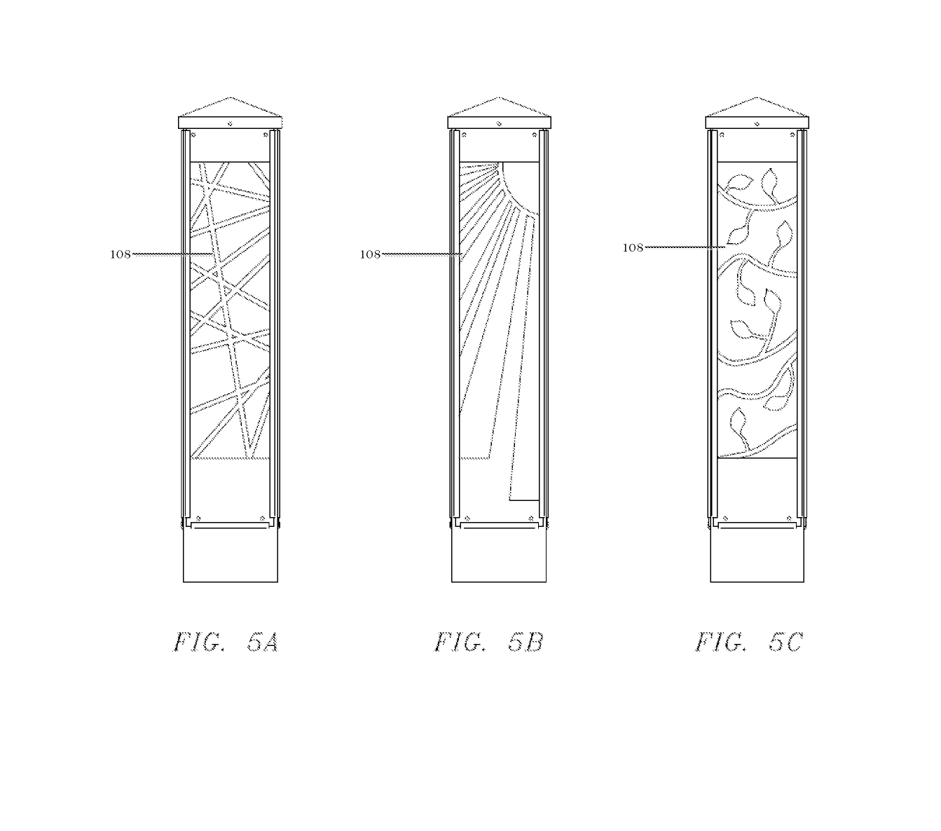

Each shadow pattern plate 102 is preferably designed to span the area (or frame) created by a cutout section 104 of an elongate tube 101. The area or framing created by a cutout section 104 provides a space for viewing a design pattern 108 incorporated into a shadow pattern plate 102. FIG. 5A through FIG. 5C shows a number of exemplary embodiments for the design pattern 108. A body of the shadow pattern plate 102 is where the design pattern 108 is incorporated. The design pattern 108 is formed by means for cutting, shaping, molding, or otherwise modifying the body to remove at least a portion of material that would otherwise be part of the body. The design pattern 108 incorporated into a shadow pattern plate 102 casts a stylized shadow onto a surface when light is projected onto the design pattern 108.

A design pattern 108 for a shadow pattern plate 102 may be created by a variety of means and/or combinations thereof for cutting, shaping, molding and/or modifying. For example, in an embodiment where the shadow pattern plate 102 starts as a sheet (or plate) of iron, then the design patterns 108 may be created using an iron cutting reciprocating saw. Furthermore, the method of creating a shadow pattern plate 102 may rely upon using a stylized pattern as a template for making the design pattern 108. With a stylized pattern, the producer (or manufacturer) of a shadow pattern plate 102 can make cuts and other modifications to the body of the shadow pattern plate 102 in order to fashion the design pattern 108 substantially similar to the stylized pattern that defines one or more solid portions and one or more voids

A shadow pattern plate 102 may have a frame (or outline) that is rectangular or square. The shadow pattern plate 102 has a plurality of edges defining its frame. For example, as demonstrated in FIG. 2B and 3B, when the elongate tube 101 is a rectangular prism (or cuboid) and the outline of a cutout section 104 is square or rectangular, a shadow pattern plate 102 may be substantially flat (i.e., the plate 102 is thin with respect to its depth or thickness). However, in other embodiments of the present disclosure, a shadow pattern plate 102 may be more three-dimensional—for example, if the elongate tube 102 is a cylinder and the cutout section 104 has curvature in its outline, a shadow pattern plate 102 may also have curvature in its frame of the curved surface to the elongate tube 101 and the cutout section 104.

A shadow pattern plate 102 may be metal, such as iron or steel. In other embodiments, a shadow pattern plate 102 may be cast, molded, cut, woven, and/or otherwise produced from other materials, such as plastic, ceramic, glass, or wicker. In other embodiments, a shadow pattern plate 102 may be constructed from a plurality of component parts secured together, including parts forming the design pattern 108.

In the present disclosure, the elongate tube 101 has a top portion 109 configured to be connected with a cover component 103, as seen in FIG. 2B and 3B. The cover component 103 is sized to a length and width sufficient for fitting over the top of and onto the elongate tube 101. In an embodiment of the present disclosure, the cover component 103 and top portion 109 of the elongate tube 101 may also be connected (or secured) to each other using means for fastening (e.g., where the cover component 103 and top portion 109 each have a plurality of apertures that align with each other for use in the application of means for fastening).

The cover component 103 may be metal, such as iron or steel. In other embodiments, the cover component 103 may be cast, molded, cut, woven, or otherwise produced from other materials, such as plastic, ceramic, or glass. In other embodiments, the cover component 103 may be constructed from a plurality of component parts secured together to form the one or more sides and roof to the covered component 103.

In one embodiment, the cover component 103 includes a lighting source 110 secured to an interior surface of the cover component 103 (FIG. 2A). In another embodiment, the cover component 103 includes the lighting source 110 secured to a bridge 112 on the interior surface of the cover component 103, where the bridge 112 acts a substrate for securing the lighting source 110 (FIG. 3A).

The lighting source 110 may project light through the elongate tube 101 and out of the light fixture 100 past the one or more shadow pattern plates 102. The lighting source 110 may use one or more LEDs, CFL lights, halogen lights, florescent lights, incandescent light bulbs, and/or other lighting bulbs, strips, arrangements, or devices.

Securing the lighting source 110 to an interior surface of the cover component 103 may provide protection of the lighting source 110 from adverse weather (e.g., rain water). Additional protections may be implemented for the lighting source 110, as well. For example, in a preferable embodiment of the present disclosure, wiring for the lighting source 110 is weather resistant (e.g., using weather resistant wire insulation). As another exemplary protection of the present disclosure, the lighting source 110 may also implement a heat sink to prevent excess heating of the cover component 103 surface from the electricity generated and used by the bulb(s) or other lighting device(s) of the lighting source 110. As yet another exemplary protection of the present disclosure, the lighting source 110 may also comprise a heat-resistant translucent casing or cover secured to the lighting source 110 and surrounding (or encasing) the bulb(s) or other lighting device(s). Such a casing may provide weather protection to the electrical components and connections in the lighting source 110, as well as protection for a person (or animal) that might come in contact with the bulb(s) or other lighting device(s). The casing would be removable (e.g., by twisting the casing off from a threaded connection to the lighting source 110, where the lighting source 110 has a circular base and spherical or cylindrical casing).

As a device for generating electric light, the lighting source 110 may comprise a switch to power the lighting device on and off The switch for the lighting source 110 may be disposed upon the light fixture 100 in a number of locations. In one embodiment, the switch may be disposed upon the interior surface of the cover component 103. In another embodiment, the switch may be disposed upon the exterior surface of the cover component 103 (such as the switch 111 in FIG. 2 and FIG. 3). In another embodiment, the switch may be disposed upon the interior surface proximal to the base of the elongate tube 101. In another embodiment of the present disclosure, the switch may be disposed upon the exterior surface proximal to the base of the elongate tube 101. In any of the preceding embodiments detailing where the switch may be disposed, the switch would be communicatively coupled with a power source of the lighting source 110 in order to switch the lighting device on and off.

The switch for the lighting 110 may also vary in its operating mechanism. In one embodiment, the switch could be a conventional mechanical switch (e.g., a lever that moves between two or more positions). In another embodiment, the switch could be a remote-controlled switch communicatively coupled with another device capable of sending an electronic signal to the change the state of the switch. In another embodiment, the switch could be timer-activated (e.g., with a set cycle to turn on the lighting source 110 between 8 p.m. and 5 a.m. and to turn off the lighting source 110 between 5 a.m. and 8 p.m.). In yet another embodiment, the switch for the lighting source 110 may be any combination of these switch types.

The power source for the lighting source 110 may take several different forms. In one embodiment, the power source may be a conventional adapter with a wired cord that ultimately connects to a power outlet. In another embodiment, the power source may be a rechargeable battery, capacitor(s), or other electric storage device that collects electric charge through solar cells wired to the storage device. A preferred example of such an embodiment would have the solar cells disposed of on the exterior of the roof to the cover component 103. Another embodiment may be any combination of these power types for the power source for the lighting source 110.

According to the present disclosure, there is also a method of producing a shadow pattern plate 102 for a light fixture 100. The method for producing the shadow pattern plate 100 may comprise creating a stylized pattern that defines one or more solid portions and one or more voids. The solid portions define where light shining on a pattern will block (or obstruct) the passage of light and the void portions define where light will pass through, the combination of which would create stylized shadows (or shadow patterns).

The method may also comprise cutting a design pattern 108 into a shadow pattern plate 102. The shadow pattern plate 102 will have a body set within a frame to the shadow pattern plate 102. Cutting the stylized pattern into at least a portion of the body to the shadow pattern plate 102 removes some portion of material from the body. The removal of material from the body creates one or more solid portions and one or more voids in the shadow pattern plate 102, and those solid portions and voids are fashioned substantially similar to the stylized pattern, resulting in the design pattern 108 for the shadow pattern plate 102.

The method may also comprise configuring a portion of the shadow pattern plate 102 to be framed by a cutout section 104 to an elongate tube 101. Configuring the shadow pattern plate 102 may include incorporating one or more apertures in the shadow pattern plate 102 so that means for fastening may secure (or connect) the shadow pattern plate 102 to the elongate tube 101. Fastening the shadow pattern plate 102 to the elongate tube 101 may enable viewing the design pattern 108 of the shadow pattern plate 102 through the cutout section 104. In another embodiment, configuring the shadow pattern plate 102 may include creating the shadow pattern plate 102 such that it fits within a plurality of pattern slots 105 on the inward-facing surface (or, in the alternative, the outward-facing surface) of the elongate tube 101. Creating the shadow pattern plate 102 to fit within a pattern slot 105 of the elongate tube 101 may also enable viewing the design pattern 108 of the shadow pattern plate 102 through the cutout section 104.

In other embodiments of the present disclosure, the method for producing a shadow pattern plate 102 may comprise additional steps. In one embodiment, the method may also comprise setting the shadow pattern plate 102 into the framing of the cutout section 104. Setting the shadow pattern plate 102 into the framing may comprise fastening the shadow pattern plate 102 to the elongate tube 101. Alternatively, setting the shadow pattern plate 102 into the framing may comprise fitting the shadow pattern plate 102 into a pattern slot 105.

As another exemplary embodiment, the method may further comprise setting a cover component 103 on top of the elongate tube 101. Such a cover component 103 may have a lighting source 110 secured to the interior surface of the cover component 103. Furthermore, the method may comprise securing a casing to the lighting source 110 to house and further protect the light bulb(s) or other lighting device(s) comprising the lighting source 110.

In yet another exemplary embodiment, the method may also comprise treating the shadow pattern plate 102 and/or elongate tube 101. As stated below, treatment of the shadow pattern plate 102 and/or elongate tube 101 may be done to create a weathered appearance.

It is understood that any reference to the elongate tube 101, cover component 103, or shadow pattern plate(s) 102 being made of metal, such as iron or steel, covers different treatments (or finishes). For example, a component may be treated such it has a weathered or aged appearance. As another example, a component may be treated such it has a polished or metallic shine. As yet another example, a component may be treated such it has a matte appearance. It is understood that these examples are not limiting of other treatments affecting the appearance of the metal used to make a component.

It is understood that certain components described herein may be electrically coupled in a number of ways. Components may be electrically coupled by one or more physical wired connections. Components may be electrically coupled by one or more intangible wireless connections. Components may be electrically coupled by a combination of one or more physical wired connections and intangible wireless connections. It is also to be understood that any reference to securing or fastening means may take a number of different forms, including threaded connections, snaps, magnets, and thumb screws.

It is understood that the specific order or hierarchy of steps in the foregoing disclosed methods are exemplary approaches. Based upon design preferences, it is understood the specific order or hierarchy of steps in the method can be rearranged while remaining within the scope of the present disclosure. The accompanying method claims present elements of the various steps in a sample order, and are not meant to be limited to the specific order or hierarchy presented.

Although the subject matter has been described in language specific to structural features and/or methodological acts, the subject matter defined in the appended claims is not necessarily limited to the specific features or acts described above. Rather, the specific features and acts described above are disclosed as example forms of implementing the claims.

The present disclosure and many of its attendant advantages will be understood by the foregoing description. It is also believed that it will be apparent that various changes may be made in the form, construction and arrangement of the modules and components thereof without departing from the scope and spirit of the disclosure or without sacrificing all of its material advantages. The form herein before described being merely an explanatory embodiment thereof, it is the intention of the following claims to encompass and include such changes.

What is claimed:

1. A light fixture that projects shadow patterns onto a surface, the light fixture comprising:
an elongate tube, where the elongate tube includes one or more cutout sections;
one or more shadow pattern plates, where a shadow pattern plate is configured to be framed by a cutout section in the elongate tube; and
a cover component configured to connect to a top portion of the elongate tube, where the cover component includes a lighting source secured to an interior surface of the cover component and configured to project light through the elongate hollow tube and out of the light fixture through the one or more shadow pattern plates.

2. The light fixture of claim 1, where the elongate tube includes a base configured to be anchored to the surface.

3. The light fixture of claim 1, where the lighting source comprises one or more LEDs.

4. The light fixture of claim 1, where the lighting source comprises a switch secured to a surface selected from the group consisting of the interior surface of the cover component, an exterior surface of the elongate tube, an interior surface of the elongate tube, and an exterior surface of the elongate tube.

5. The light fixture of claim 1, where the cover component further comprises an exterior surface with one or more solar cells disposed thereon and connected to the lighting source.

6. The light fixture of claim 1, where at least the elongate tube and the shadow pattern plate are made of treated steel.

7. The light fixture of claim 1, where at least the shadow pattern plate is made from material selected from the group consisting of plastic, glass, ceramic, and wicker.

8. A shadow pattern plate for creating a stylized shadow on a surface, the shadow pattern plate comprising:
a plurality of edges defining a frame for the shadow pattern plate; and
a body set within the frame, the body defining a design pattern for the shadow pattern plate, where
the design pattern is formed by means for cutting the body to remove at least a portion of material that would otherwise be part of the body; and
the stylized shadow is created by means for projecting light onto the body of the shadow pattern plate with the design pattern of the body obstructing at least a portion of the light from passing onto the surface.

9. The shadow pattern plate of claim 8, the shadow pattern plate being configured to be secured to a cutout section on an elongate tube of a light fixture using means for fastening.

10. The shadow pattern plate of claim 8, where the plurality of edges defining the frame form a rectangle.

11. The shadow pattern plate of claim 8, where the plurality of edges defining the frame form a side surface to a cylinder.

12. The shadow pattern plate of claim 8, where the shadow pattern plate is made from material selected from the group consisting plastic, glass, ceramic, and wicker.

13. The shadow pattern plate of claim 8, where the design pattern is fashioned substantially similar to a stylized pattern defining one or more solid portions and one or more voids.

14. A method of producing a shadow pattern plate for a light fixture, the method comprising:
creating a stylized pattern defining one or more solid portions and one or more voids;
cutting a design pattern into at least a portion of a body to a shadow pattern plate, where cutting removes at least a portion of material from the body to define one or more solid portions and one or more voids in a fashion substantially similar to the stylized pattern; and
configuring at least a portion of the shadow pattern plate for framing by a cutout section on an elongate tube.

15. The method of claim 14, further comprising:
setting the shadow pattern plate into the framing of the cutout section on the elongate hollow tube.

16. The method of claim 15, further comprising:
setting a cover component atop the elongate tube, where a lighting source is secured to an interior surface of the cover component.

17. The method of claim 14, further comprising:
treating at least the shadow pattern plate to create a weathered appearance.

18. The method of claim 14, where the shadow pattern plate is made from material selected from the group consisting of plastic, glass, ceramic, and wicker.
